(19) United States
(12) Patent Application Publication
(10) Pub. No.: US 2016/0122684 A1
(43) Pub. Date: May 5, 2016

(54) Method for Aqueous Enzymatic Extraction of Soybean Oil

(71) Applicants: Lianzhou Jiang, Harbin (CN); Yang Li, Harbin (CN); Xiaonan Sui, Harbin (CN); Baokun Qi, Harbin (CN); Zhongjiang Wang, Harbin (CN); Yan Zhang, Harbin (CN); Hongxia Feng, Harbin (CN); Huan Wang, Harbin (CN); Wenjun Ma, Harbin (CN)

(72) Inventors: Lianzhou Jiang, Harbin (CN); Yang Li, Harbin (CN); Xiaonan Sui, Harbin (CN); Baokun Qi, Harbin (CN); Zhongjiang Wang, Harbin (CN); Yan Zhang, Harbin (CN); Hongxia Feng, Harbin (CN); Huan Wang, Harbin (CN); Wenjun Ma, Harbin (CN)

(73) Assignee: Northeast Agricultural University, Harbin (CN)

(21) Appl. No.: 14/694,133

(22) Filed: Apr. 23, 2015

(30) Foreign Application Priority Data
Oct. 31, 2014 (CN) 201410605037.7

(51) Int. Cl. C11B 1/10

(52) U.S. Cl. CPC C11B 1/10

(57) ABSTRACT

The present invention provides a method for aqueous enzymatic extraction of soybean oil, which is in the field of extraction processing technology for plant oil. The method comprises treating crushed and peeled soybeans with an extrusion puffing process and a hydrolysis process with an alkaline proteinase, followed by a liquid nitrogen freezing and a high voltage electrostatic thawing process, and finally obtaining soybean oil by centrifugation. The benefits of the present invention includes short extraction time and high extraction yield. It saves up to 93.1% of time in the freezing and thawing process alone. The total oil yield is up to 95.4%. Furthermore, the method of the invention produces high quality oil with a low peroxide value, a low p-anisidine value and a low TOTOX value.

### CROSS-REFERENCES AND RELATED APPLICATIONS

This application claims the benefit of priority to Chinese Application No. 201410605037.7, entitled “A Method for Aqueous Enzymatic Extraction of Soybean Oil”, filed Oct. 31, 2014, which is herein incorporated by reference in its entirety.

### BACKGROUND OF THE INVENTION

1. Field of the Invention

The present invention relates to the field of extraction processing technology for plant oil. In particular, it relates methods for aqueous enzymatic extraction of soybean oil combined with a freeze-thaw demulsification method.

2. Description of the Related Art

Aqueous enzymatic extraction of oil is a novel biological extraction technology, which is safer and more reliable than traditional extraction methods. Aqueous enzymatic extraction technology uses enzymes that can degrade plant cell walls or the ones that can degrade lipidprotein and lipopolysaccharide complexes to digest oil seeds, making oil to be easily released from the seeds. Oil is separated from non-oil components based on the difference of specific gravity and affinity between oil and non-oil components. Compared to traditional extraction methods, aqueous enzymatic extraction method is simpler and safer to operate and performs under mild conditions, providing great advantages in terms of energy saving, environment protection, health and safety. However, the oil yield is relatively low for extracting soybean oil by aqueous enzymatic technology because of emulsification of protein, oil and water.

In recent years, the freeze-thaw demulsification method is widely used in edible oil processing and extraction because it avoids the use of organic solvents, toxic and hazardous chemicals in the extraction process. Van Boekel et al studied the stability of the emulsion, and used the freeze-thaw method to break the emulsion. They proposes that freeze-thaw cycles can make the emulsion unstable because the oil phase of emulsion crystallizes during the freezing process. These lipid crystals may pierce the aqueous phase. If the lipid crystals happens to appear between adjacent oil droplets, they will aggregate to form large oil drops by piercing through the interface film, thus greatly reducing the stability of the emulsion and breaking the emulsion. Fennema et al have done similar studies. They suggested that ice crystals of the emulsion formed during the freezing process will force the emulsion droplets to get close to each other, which causes serious droplets coalescence during the thawing process. Lamsal et al have achieved a high demulsification rate using the freeze-thaw method to break soybean oil emulsion made from aqueous enzymatic extraction. Yingyao Wang et al. have studied the freeze-thaw method for breaking emulsion generated by aqueous enzymatic extraction of peanut protein and oil. The emulsion was frozen at −20° C. for 15 hours, thawed at 35° C. for two hours, and centrifuged at 3000 rpm for 20 minutes. The emulsion breaking rate was up to 91.6%. ShaoBing Zhang et al. have studied the methods for breaking emulsion generated by aqueous enzymatic extraction of rapeseed oil and protein. The method comprises two steps: first, the emulsion was placed at 4° C. for 1 day. After centrifugation at different speeds for 20 minutes, the upper oil phase was obtained and the aqueous phase was discarded. Secondly, residual emulsion obtained after the centrifugation was frozen at −18° C. for 20 hours, thawed at 40° C. for 2 hours and centrifuged at 10,000 rpm for 20 minutes. The oil was retrieved from the upper oil phase of the centrifugate. The demulsification rate is 75%. However, current freeze-thaw techniques are carried out at relatively high temperatures, takes long processing time, and has low reaction efficiency, relatively low rate of demulsification and low oil yield. It cannot satisfy the requirements of industrial mass production.

Liquid nitrogen freezing technique has many advantages such as fast freezing speed, short freezing time, good freezing quality, and no pollution. It is a green processing technology. Liquid nitrogen freezing provides a large degree of supercooling for both oil and aqueous phase that can facilitate rapid nucleation and crystallization. Rapid crystallization of continuous oil phase makes the crystallization process more disordered and easier to form tiny cracks. On the other hand, rapid congelation of dispersed drops increases the volume expansion power acting on the continuous phase of crystallization, which is beneficial for breaking oil cages. Rapid freezing transformation reaction of oil and water phases makes the continuous phase of crystallization to produce more tiny cracks. The smaller the crystallization cracks of continuous phase are, the stronger the capillary pressure is. The non-freezing liquid of dispersed phase is easier to seeping into the cracks due to strong capillary action. Compared with other freezing methods, liquid nitrogen rapid freezing is easier to form a more intensive and huge microchannel network, connecting more frozen droplets. More droplets gather together under the interfacial tension during the thawing process, which leads to more complete separation of oil and water phase. However, currently liquid nitrogen freezing technology is mainly used for demulsification in the exploitation of crude oil, which has not yet applied to the field of edible oil processing technology.

High voltage electrostatic thawing is a new technology of thawing with great potentials. This method is to place the frozen food in a high voltage electrostatic field at a low temperature of 0-10° C., using a variety of effect produced by micro energy of high voltage electric field to make the food thaw. This technology has the advantages of short thawing time, good thawing effect, and better protection of the activity of nutrients. However, current application of high voltage electrostatic thawing method is mainly confined to the thawing of frozen food such as frozen meat etc, which has not applied in thawing emulsion or extracting oil.

### DETAILED DESCRIPTION

To solve the above problems, the present invention provides a method for aqueous enzymatic extraction of soybean oil combined with liquid nitrogen freezing and high voltage electrostatic thawing demulsification technologies.

The goal of the present invention is to provide a method for aqueous enzymatic extraction of soybean oil. Soybeans are cleaned, peeled and crushed. The crushed soybean is treated with an extrusion puffing process to obtain a puffed extrudate. The puffed extrudate is hydrolyzed using an alkaline protease. The enzymolysate is frozen in liquid nitrogen. Finally, the frozen enzymolysate is thawed using a high voltage electrostatic method and centrifuged to obtain soybean oil.

The method comprises the following steps:
1) Soybean is cleaned and peeled and crushed to obtain a crushed soybean;
2) The crushed soybean (from step 1) is treated with a extrusion puffing process to obtain a puffed extrudate;
3) The puffed extrudate (from step 2) is crushed and mixed with water, and is hydrolyzed by an alkaline protease to obtain an enzymolysate;
4) The enzymolysate from step 3) is cooled down to ambient temperature, and frozen using liquid nitrogen to obtain a frozen enzymolysate;
5) The frozen enzymolysate from step 4) is thawed using a high voltage electrostatic method to obtain a thawed enzymolysate;
6) Soybean oil is obtained by centrifuging the thawed enzymolysate from step 5).

The condition for the extrusion puffing process in step 2) is as follows: sleeve temperature is 70-130° C., die aperture is 12-24 mm, screw speed is 60-140 rpm, water content is 10%-18%. The enzyme used in the enzymolysis processing in step 3) can be, for example, Alcalase. The enzymolysis conditions is as follows: ratio of extruded material to water is 1:4-8, the amount of enzyme is 1-5%, enzymolysis temperature is 45-65° C., pH is 7-11 and the reaction time is 1-5 hours.

The preferred condition for the extrusion puffing process is as follows: sleeve temperature is 95° C., die aperture is 18 mm, screw speed is 110 rpm and water content is 15%. The preferred condition for the enzymolysis process is as follows: ratio of extruded material to water is 1:6.5, amount of enzyme is 2.5%, enzymolysis temperature is 55° C., pH is 9.5 and the reaction time is 3.5 hours.

The liquid nitrogen freezing process in step 4) uses −196° C. liquid nitrogen with a freezing time of 10-50 minutes. The high voltage electrostatic thawing process in step 5) performs under electric field intensity of 100-300 kV/m, thawing temperature of 0-10° C., and thawing time of 10-50 minutes.

Under the preferred condition, the liquid nitrogen freezing process uses −196° C. liquid nitrogen with a freezing time of 40 minutes. Under the preferred condition, the high voltage electrostatic process performs under electric field intensity of 200 kV/m with a thawing temperature of 6° C. and a thawing time of 30 minutes.

In a preferred embodiment, the present invention comprises the following steps:
1) Soybean is cleaned, peeled and crushed to obtain a crushed soybean;
2) the crushed soybean in step 1) is treated with an extrusion puffing process to obtain a puffed extrudate wherein the extrusion puffing process is conducted under the following condition: sleeve temperature is 95° C., die aperture is 18 mm, screw speed is 110 rpm and water content is 15%;
3) the puffed extrudate obtained in step 2) is mixed with water and is hydrolyzed by Alcalase to obtain an enzymolysate wherein the enzymolysis condition is as follows: ratio of extruded material to water is 1:6.5, the amount of enzyme is 2.5%, the enzymolysis temperature is 55° C., pH is 9.5 and the reaction time is 3.5 hours;
4) the enzymolysate obtained in step 3) is cooled down to ambient temperature, and frozen in liquid nitrogen (−196° C.) for 40 minutes;
5) the frozen enzymolysate obtained in step 4) is thawed using a high voltage electrostatic method, wherein the high voltage electrostatic thawing process performs under electric field intensity of 200 kV/m with a thawing temperature of 6° C. and a thawing time of 30 minutes;
6) Soybean oil is obtained by centrifuging the thawed enzymolysate from step 5).

The present invention combines extrusion assisted aqueous enzymatic extraction technology with the liquid nitrogen freezing and high voltage electrostatic thawing method to extract soybean oil. Liquid nitrogen freezing can provide a huge degree of supercooling for both oil and water phase at the same time, which makes the two phases form rapid nucleation and crystallization. Rapid freezing transformation reaction of oil and water makes the continuous phase of crystallization produce more tiny cracks. Under the capillary pressure, the non-freezing liquid of dispersed phase seeps into the cracks, which forms a more intensive microchannel network, connecting more frozen drops. Frozen drops are rapidly thawed by high voltage electrostatic thawing technology. More drops gather together under the effect of interfacial tension in the thawing process, which leads to more complete separation of oil-water phase. This method has the advantages of short extraction time and high extraction efficiency. The soybean oil produced by the invented method has a low peroxide value and is resistant to oxidation. In addition, nitrogen is easy to recycle and produces no pollution.

The present invention provides an extrusion assisted aqueous enzymatic extraction method for extracting soybean oil, which is combined with liquid nitrogen freezing and high voltage electrostatic thawing technology. This method shortens the extraction time, enhances extraction efficiency, and can maintain the maximum nutritional value of the oil. The soybean oil of the present invention is a high quality product with low peroxide value and strong antioxidant activity. The method is environmental friendly and produces no pollution. More importantly, the invented method can be adapted to continuous and large scale industrial application, making it a favorable option for industrial production of soybean oil.

### BRIEF DESCRIPTION OF THE DRAWINGS

FIG. 1 is a diagram showing the work flow of the present invention.

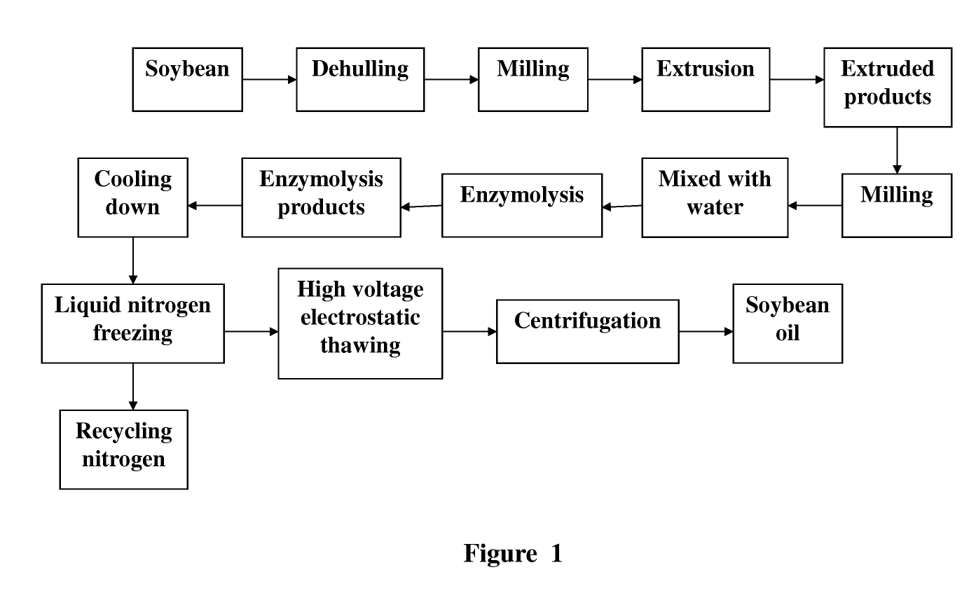

FIG. 2 shows the effect of traditional freeze-thaw conditions on final yield of total oil. a, the effect of freezing temperature on final yield of total oil; b, the effect of freezing time on final yield of total oil; c, the effect of thawing temperature on final yield of total oil; d, the effect of thawing time on final yield of total oil.

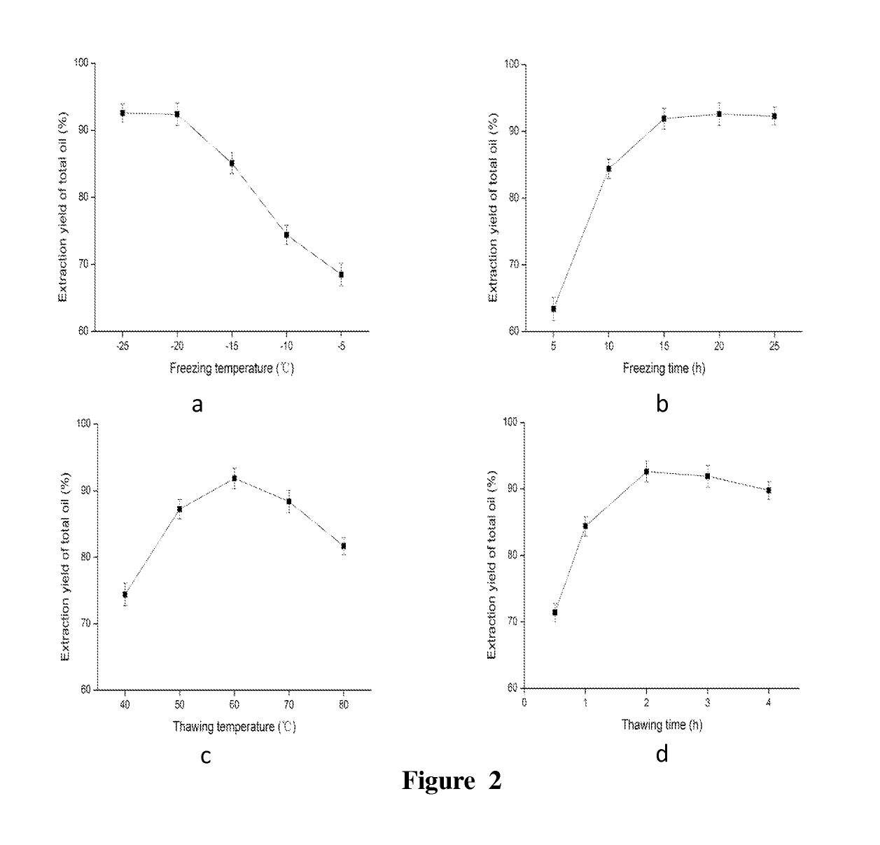

FIG. 3 shows the effect of freeze-thaw conditions of the present invention on final yield of total oil. a, the effect of liquid nitrogen freezing time on final yield of total oil; b, the effect of electric field intensity on final yield of total oil; c, the effect of thawing temperature on final yield of total oil; d, the effect of thawing time on final yield of total oil.

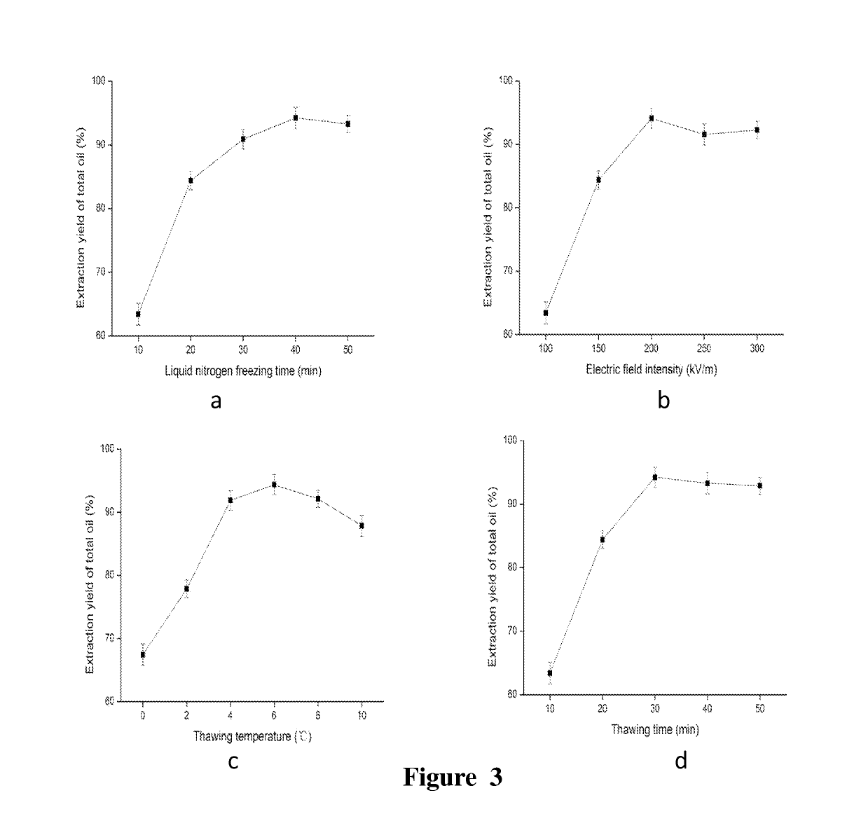

### EXAMPLES

The following examples are provided for illustration purposes, are not intended to limit the scope of the invention, which is limited only by the claims.

The materials, reagents, instruments and methods used in the present invention without special instructions are conventional materials, reagents, instruments and existing methods in the art, which can be obtained through commercial channels, and are well known to person with ordinary skills in the art.

### Example 1

This example provides an extraction method of soybean oil by traditional freeze-thaw method. The method comprises the following steps:

Soybean was peeled and crushed. The crushed soybean was treated by an extrusion puffing process to obtain a puffed extrudate wherein the sleeve temperature was 95° C., die aperture was 18 mm, screw speed was 100 rpm, and water content was 14%. The puffed extrudate was crushed and mixed with water, which was then hydrolyzed for 3 hours with 3% Alcalase. The conditions for hydrolyzation reaction was as follows: ratio of water to extrudate was 6:1 (ml:g), enzymolysis temperature was 55° C., pH 9.0 and reaction time was 3 hours. The enzymolysate was frozen at −20° C. for 15 hours and thawed at 60° C. for 2 hours. Soybean oil was obtained from the upper oil phase of the centrifugate of the thawed enzymolysate.

### Example 2

This example provides an exemplary method of the instant invention for extracting soybean oil using liquid nitrogen freezing and high voltage electrostatic thawing method. The method comprises the following steps:

Soybean was peeled and crushed. The crushed soybean was treated by an extrusion puffing process to obtain a puffed extrudate wherein sleeve temperature was 95° C., die aperture was 18 mm, screw speed was 110 rpm, and water content was 15%. The puffed extrudate was crushed and mixed with water, which was then hydrolyzed for 3.5 hours with 2.5% Alcalase. The conditions for hydrolyzation reaction was as follows: ratio of water to extrudate was 6.5:1 (ml:g), enzymolysis temperature was 55° C., pH 9.5 and reaction time was 3.5 hours. After cooling down to room temperature, the enzymolysate was frozen in liquid nitrogen (−196° C.) for 40 minutes and thawed under a high voltage electric field (electric field intensity: 200 kV/m), at 6° C. for 30 minutes. Soybean oil was obtained from the upper oil phase of the centrifugate of the thawed enzymolysate.

### Example 3

This example provides another exemplary method of the instant invention for extracting soybean oil. The method comprises the following steps:

Soybean was peeled and crushed. The crushed soybean was treated by an extrusion puffing process to obtain a puffed extrudate wherein the sleeve temperature was 100° C., die aperture was 20 mm, screw speed was 120 rpm, and water content was 16%. The puffed extrudate was crushed and mixed with water, which was then hydrolyzed for 3 hours with 3% Alcalase. The conditions for hydrolyzation reaction is as follows: ratio of water to extrudate was 7:1 (ml:g), enzymolysis temperature was 50° C., pH 9.0 and reaction time was 3 hours. After cooling down to room temperature, the enzymolysate was frozen in liquid nitrogen (−196° C.) for 30 minutes and thawed under a high voltage electric field (electric field intensity: 150 kV/m), at 8° C. for 40 minutes. Soybean oil was obtained from the upper oil phase of the centrifugate of the thawed enzymolysate.

### Example 4

This example provides another exemplary method of the instant invention for extracting soybean oil. The method comprises the following steps:

Soybean was peeled and crushed. The crushed soybean was treated by an extrusion puffing process to obtain a puffed extrudate wherein the sleeve temperature was 90° C., die aperture was 16 mm, screw speed was 100 rpm, and water content was 14%. The puffed extrudate was crushed and mixed with water, which was then hydrolyzed for 4 hours with 2% Alcalase. The conditions for hydrolyzation reaction is as follows: ratio of water to extrudate was 6:1 (ml:g), enzymolysis temperature was 60° C., pH 10.0 and reaction time was 4 hours. After cooling down to room temperature, the enzymolysate was frozen in liquid nitrogen (−196° C.) for 50 minutes and thawed under a high voltage electric field (electric field intensity: 250 kV/m), at 4° C. for 20 minutes. Soybean oil was obtained from the upper oil phase of the centrifugate of the thawed enzymolysate.

### Example 5

This example compares the conditions and effects of soybean oil extraction methods of examples 1-4. The operational condition and final yield of total oil in Example 1 and 2 are shown in Table 1 and 2, respectively.

TABLE 1
Final yield of total oil of a traditional
freeze-thaw method in Example 1

| Operation Conditions | | | | |
|---|---|---|---|---|
| Freezing | Freezing | Thawing | Thawing | Final yield |
| temperature | time | temperature | time | of total |
| (° C.) | (hours) | (° C.) | (hours) | oil (%) |
| −20 | 15 | 60 | 2 | 92.47 |

TABLE 2
Final yield of total oil of a freeze-thaw method
of the present invention in Example 2

| Operation Conditions | | | | |
|---|---|---|---|---|
| Liquid nitro- | electric | Thawing | Thawing | Final yield |
| gen freezing | field inten- | temperature | time | of total |
| time (min) | sity (kV/m) | (° C.) | (min) | oil (%) |
| 40 | 200 | 6 | 30 | 95.36 |

From the comparison of Table 1 and 2, it can be seen that the soybean oil extraction method of the invention has a higher yield of total oil and a much shorter extraction time than that of traditional freeze-thaw method. The freezing step of the traditional method takes 15 hours, whereas the liquid nitrogen freezing method of the invention only takes 40 minutes. The thawing time by high voltage electrostatic method of the invention is 30 minutes, compared to 2 hour thawing time of traditional method. For the freezing and thawing process, the extraction method of the invention only consumes 6.9% of that of the traditional freeze-thaw method. The present invention provides a soybean oil extraction method that has a higher yield and consumes less time, thus greatly improving the extraction efficiency.

Important indexes to evaluate the quality of an oil product include peroxide value, p-anisidine value and TOTOX value. The peroxide value measures the content of hydroperoxide in an oil product, a measure for the primary stage of oxidation. The p-anisidine value measures the content of secondary oxidation products produced by hydroperoxide, which is used for measuring secondary stage of oil oxidation. TOTOX value, a combination of p-anisidine value and peroxide value, is usually used for evaluating total oxidation level of an oil product. Table 3 shows peroxide value, p-anisidine value, TOTOX value and total yield of soybean oil for methods in Examples 1-4.

TABLE 3
Comparison of quality of soybean oil prepared in Example 1-4

| | Peroxide value | p-Anisidine | TOTOX | yield of |
|---|---|---|---|---|
| | (mmol/kg) | value | value | total oil |
| Example 1 | 3.24 | 6.42 | 12.9 | 92.47% |
| Example 2 | 2.83 | 6.13 | 11.79 | 95.36% |
| Example 3 | 2.86 | 6.21 | 11.93 | 94.89% |
| Example 4 | 2.91 | 6.16 | 11.98 | 95.14% |

The oxidation indexes of soybean oil prepared in Examples 1-4 were measured according to the GB/T5009.37 standardized methods. The peroxide value of soybean oil prepared by the traditional method (Example 1) is 3.24 mmol/kg. The peroxide value of soybean oil prepared by the freeze-thaw method of the invention (Examples 2-4) ranges from 2.83 to 2.91 mmol/kg, which indicates the primary oxidation level of soybean oil prepared by the method of the present invention is lower than that of the traditional method. The p-anisidine value of soybean oil made in Examples 2-4 ranges from 6.13 to 6.21, which is also lower than that (6.42) of soybean oil prepared by the traditional method (Example 1). Oxidation state of soybean oil is indicated by TOTOX value (TOTOX=2×peroxide value+p-anisidine value). The TOTOX value of soybean oil prepared by the freeze-thaw method of the invention ranges from 11.79-11.98 (Example 2-4), which is lower than that (12.90) of the traditional method. At the same time, the total oil yields in Example 2-4 are all higher than that of the traditional method in Example 1. These data show that the soybean extraction method of the invention produces high quality oil with improved extraction efficiency.

While the present invention has been described in some detail for purposes of clarity and understanding, one skilled in the art will appreciate that various changes in form and detail can be made without departing from the true scope of the invention. All figures, tables, appendices, patents, patent applications and publications, referred to above, are hereby incorporated by reference.

What is claimed is:

1. A method for aqueous enzymatic extraction of soybean oil, comprising the steps of:
1). treating peeled and crushed soybean by an extrusion puffing process to obtain a puffed extrudate;
2). hydrolyzing the puffed extrude using an alkaline protease to obtain an enzymolysate;
3). freezing the enzymolysate using liquid nitrogen;
4). thawing the frozen enzymolysate using a high voltage electrostatic method; and
5). centrifuging the thawed enzymolysate to obtain soybean oil.

2. The method of claim 1, comprising the steps of:
1). cleaning, peeling and crushing soybean to obtain a crushed soybean;
2). treating the crushed soybean by a extrusion puffing process to obtain a puffed extrudate;
3). mixing the puffed extrudate with water, and hydrolyzing it with alkaline protease to obtain a enzymolysate;
4) cooling the enzymolysate to ambient temperature, and freezing it using liquid nitrogen to obtain a frozen enzymolysate;
5) thawing the frozen enzymolysate using a high voltage electrostatic method to obtain a thawed enzymolysate;
6) centrifuging the thawed enzymolysate to obtain soybean oil.

3. The method of claim 2, wherein the condition for said extrusion puffing process in step 2) is as follows: sleeve temperature is 70-130° C., die aperture is 12-24 mm, screw speed is 60-140 rpm, and the water content is 10-18%; and wherein Alcalase is used in the enzymolysis process of step 3) and the enzymolysis condition is as follows: ratio of the puffed extrudate to water is 1:4-8, enzyme amount is 1-5%, temperature is 45-65° C., pH is 7-11 and reaction time is 1-5 hours.

4. The method of claim 3, wherein the condition of said extrusion puffing process is as follows: sleeve temperature is 95° C., die aperture is 18 mm, screw speed is 110 rpm and water content is 15%; wherein said enzymolysis condition is as follows: ratio of the puffed extrudate to water is 1:6.5, enzyme amount is 2.5%, temperature is 55° C., pH is 9.5 and the reaction time is 3.5 hours.

5. The method of claim 2, wherein said liquid nitrogen freezing process in step 4) uses liquid nitrogen of −196° C., and a freezing time of 10-50 minutes.

6. The method of claim 5, wherein the freezing time is 40 minutes.

7. The method of claim 2, wherein the condition for the high voltage electrostatic process in step 5) is as follows: electric field intensity is 100-300 kV/m, thawing temperature is 0-10° C. and thawing time is 10-50 minutes.

8. The method of claim 7, wherein the electric field intensity is 200 kV/m, the thawing temperature is 6° C. and the thawing time is 30 minutes.

9. The method of claim 2, comprising the steps of:
1) cleaning, peeling and crushing soybean to obtain a crushed soybean;
2) treating the crushed soybean by a extrusion puffing process to obtain a puffed extrudate, wherein the condition of the extrusion puffing process is as follows: sleeve temperature is 95° C., die aperture is 18 mm, screw speed is 110 rpm and water content is 15%.
3) mixing the puffed extrudate with water, and hydrolyzing it with Alcalase to obtain an enzymolysate, wherein the enzymolysis condition is as follows: ratio of the puffed extrudate to water is 1:6.5, enzyme amount is 2.5%, temperature is 55° C., pH 9.5 and reaction time is 3.5 hours.
4) cooling the enzymolysate to ambient temperature, and freezing it in −196° C. liquid nitrogen for 40 minutes to obtain a frozen enzymolysate;
5) thawing the frozen enzymolysate under an electrostatic field of 200 kV/m, temperature of 6° C. for 30 minutes to obtain a thawed enzymolysate; and
6) obtaining soybean oil by centrifuging the thawed enzymolysate.
